(19) United States
(12) Patent Application Publication
(10) Pub. No.: US 2011/0304719 A1
(43) Pub. Date: Dec. 15, 2011

(54) IMAGE PROCESSING APPARATUS, IMAGE PROCESSING METHOD, PROGRAM, AND ELECTRONIC APPARATUS

(75) Inventor: Taketoshi Sekine, Shizuoka (JP)

(73) Assignee: SONY CORPORATION, Tokyo (JP)

(21) Appl. No.: 13/149,115

(22) Filed: May 31, 2011

(30) Foreign Application Priority Data
Jun. 14, 2010 (JP) 2010-135308

(51) Int. Cl. H04N 7/18

(52) U.S. Cl. 348/77; 348/E07.085

(57) ABSTRACT

An image processing apparatus which detects a skin area indicating human skin on an image includes a first irradiation unit which irradiates a subject with light with a first wavelength, a second irradiation unit which irradiates the subject with light with a second wavelength, a generation unit which generates a first image based on reflected light incident from the subject when the light with the first wavelength is radiated and generates a second image based on reflected light incident from the subject when the light with the second wavelength is radiated, a correction unit which corrects at least one of a luminance value of the first image, a luminance value of the second image, and a threshold value to be compared to a difference between the luminance values of the first image and the second image, and a detection unit which detects the skin area based on the comparison result.

### CROSS REFERENCES TO RELATED APPLICATIONS

The present disclosure claims priority to Japanese Priority Patent Application JP 2010-135308 filed in the Japan Patent Office on Jun. 14, 2010, the entire contents of which are hereby incorporated by reference.

### BACKGROUND

The present disclosure relates to an image processing apparatus, an image processing method, a program, and an electronic apparatus, and particularly to an image processing apparatus, an image processing method, a program, and an electronic apparatus that enable detection of a portion in which skin, for example, of a hand of a person, or the like is exposed from a captured image.

In the related art, there is an area detection technology for detecting an area with a certain characteristic from a captured image obtained by imaging a subject (for example, a person).

The area detection technology is applied to various electronic apparatuses, for example, digital cameras, television receivers, and the like. To be more specific, there are digital cameras that, for example, conduct a shutter operation when the face of a person is detected from a through image for composition determination and the detected face is a smiling face.

In addition, there are digital cameras that, for example, detect the face of a person from a captured image obtained by capturing, and correct shaking or the like occurring in the area of the detected face based on the detection result.

Furthermore, there are television receivers that, for example, detect body or hand gestures of a person from a captured image obtained by imaging a subject by a built-in camera, and switch channels according to the detection result.

Herein, as an area with a certain characteristic, there is a skin detection technology that detects an area where skin such as of a face, hand, or the like is exposed (hereinafter, referred to as a skin area) from a captured image obtained by imaging a person (for example, refer to Japanese Unexamined Patent Application Publication Nos. 2006-47067, 06-123700, and 05-329163).

In this skin detection technology, a first image obtained by imaging a subject (person) in a state of being irradiated with LEDs (Light Emitting Diodes) emitting light with a wavelength of λ1 and a second image obtained by imaging a subject in a state of being irradiated with LEDs emitting light with a wavelength of λ2 that is different from the wavelength of λ1 are acquired. Then, an area where the difference in luminance values of the first image and the second image is greater than a predetermined threshold value is detected as the skin area.

Furthermore, the wavelengths of λ1 and λ2 are determined depending on the reflection characteristic of human skin. In other words, the reflectance of the wavelengths of λ1 and λ2 has different values when the light beams thereof are radiated on human skin, and the reflectance thereof is determined substantially at the same level when the light beams thereof are radiated on portions other than human skin (for example, hair on heads, clothes, or the like). To be more specific, for example, the wavelength of λ1 is set to 870 nm, and the wavelength of λ2 to 950 nm.

### SUMMARY

In the skin detection technology, an area where the difference in luminance values of the first image in the state of being irradiated with the wavelength of λ1 and the second image in the state of being irradiated with the wavelength of λ2, which corresponds to the difference in reflectance of the subjects, is greater than a predetermined threshold value is detected as a skin area.

Therefore, as the difference corresponds to the difference in reflectance of the subjects in the skin detection technology, it is necessary to satisfy a condition that a ratio of the illuminance of light with the wavelength of λ1 to the illuminance of light with the wavelength of λ2 for a subject (illuminance ratio) is a certain value.

When the condition is not satisfied, it is not able to discriminate whether the difference in luminance values of the first image in the state of being irradiated with the wavelength of λ1 and the second image in the state of being irradiated with the wavelength of λ2 is derived from a difference in spectral reflectance of the subjects, or from a difference in illuminance of LEDs radiating light with the wavelength of λ1 and LEDs radiating light with a wavelength of λ2, thereby making it not possible to detect a skin area with high accuracy.

The present disclosure takes the above circumstance into consideration, and it is desirable to detect a skin area with high accuracy in a skin detection technology using a plurality of light beams with different wavelengths when unevenness occurs in an illuminance ratio by a plurality of light beams with different wavelengths.

According to an embodiment of the disclosure, there is an image processing apparatus which detects a skin area indicating human skin on an image including a first irradiation unit which irradiates a subject with light with a first wavelength, a second irradiation unit which irradiates the subject with light with a second wavelength that is a longer wavelength than the first wavelength, a generation unit which generates a first image based on reflected light incident from the subject when the light with the first wavelength is radiated on the subject and generates a second image based on reflected light incident from the subject when the light with the second wavelength is radiated on the subject, a correction unit which corrects at least one of a luminance value of the first image, a luminance value of the second image, and a threshold value to be compared to a difference between the luminance values of the first image and the second image using a correction value used in correction, and a detection unit which detects the skin area based on the comparison result of the difference and the threshold value.

The correction unit may correct at least one of the corresponding luminance values or the threshold value for a coordinate of a pixel present on the first or the second image.

A calculation unit which calculates a distance to the subject may be further provided, and the correction unit may correct at least one of the luminance value and the threshold value using a correction value corresponding to the distance to the subject among a plurality of correction values respectively corresponding to each different distance.

The correction unit may correct at least one of the luminance value and the threshold value by performing addition or subtraction of the correction value.

The correction unit may correct at least one of the luminance value and the threshold value by performing multiplication or division of the correction value.

The first wavelength of λ1 and the second wavelength of λ2 may satisfy the relationship of the following formulae:

630[nm]<λ1≦1000[nm]

900[nm]<λ2≦1100[nm].

The first and second irradiation units may radiate light in a state where the illuminance ratio of the illuminance of light with the first wavelength and illuminance of light with the second wavelength deviates from a predetermined value by 3% or more.

According to another embodiment of the technology, there is provided an image processing method of an image processing apparatus which detects a skin area indicating human skin on an image and includes a first irradiation unit, a second irradiation unit, a generation unit, a correction unit, and a detection unit, and the method includes irradiating a subject with light with a first wavelength by the first irradiation unit, irradiating the subject with light with a second wavelength that has a longer wavelength than the first wavelength by the second irradiation unit, generating a first image based on reflected light incident from the subject when light with the first wavelength is radiated on the subject and generating a second image based on reflected light incident from the subject when light with the second wavelength is radiated on the subject, by the generation unit, correcting at least one of a luminance value of the first image, a luminance value of the second image, and a threshold value to be compared to the difference between the luminance value of the first image and the second image using a correction value used in correction by the correction unit, and detecting the skin area by the detection unit based on the comparison result of the difference and the threshold value.

According to still another embodiment of the technology, there is provided a program for causing a computer to function as a correction unit which corrects at least one of a luminance value of the first image, a luminance value of the second image, and a threshold value to be compared to the difference between the luminance values of the first image and the second image using a correction value used in correction, and a detection unit which detects a skin area based on the comparison result of the difference and the threshold value, and the computer controls an image processing apparatus for detecting a skin area indicating human skin on an image including a first irradiation unit which irradiates a subject with light with a first wavelength, a second irradiation unit which irradiates the subject with light with a second wavelength that is a longer wavelength than the first wavelength, and a generation unit which generates a first image based on reflected light incident from the subject when light with the first wavelength is radiated on the subject and generates a second image based on reflected light incident from the subject when light with the second wavelength is radiated on the subject.

According to the embodiment of the technology, at least one of a luminance value of the first image, a luminance value of the second image, and a threshold value to be compared to the difference between the luminance value of the first image and the second image is corrected using a correction value used in correction, and the skin area is detected based on the comparison result of the difference and the threshold value.

According to still another embodiment of the technology, an electronic apparatus which detects a skin area indicating human skin on an image including a first irradiation unit which irradiates a subject with light with a first wavelength, a second irradiation unit which irradiates the subject with light with a second wavelength having a longer wavelength than the first wavelength, a generation unit which generates a first image based on reflected light incident from the subject when the light with the first wavelength is radiated on the subject and generates a second image based on reflected light incident from the subject when the light with the second wavelength is radiated on the subject, a correction unit which corrects at least one of a luminance value of the first image, a luminance value of the second image, and a threshold value to be compared to a difference between the luminance values of the first image and the second image using a correction value used in correction, a detection unit which detects the skin area based on the comparison result of the difference and the threshold value, and an execution unit which executes a predetermined process based on the detected skin area.

According to the embodiment of the technology, light with a first wavelength is radiated on a subject, light with a second wavelength that is a longer wavelength than the first wavelength is radiated on the subject, a first image is generated based on reflected light incident from the subject when light with the first wavelength is radiated on the subject and the second image is generated based on reflected light incident from the subject when light with the second wavelength is radiated on the subject. In addition, at least one of a luminance value of the first image, a luminance value of the second image, and a threshold value to be compared to the difference between the luminance values of the first image and the second image is corrected using a correction value used in correction, the skin area is detected based on the comparison result of the difference and the threshold value, and a predetermined process is executed based on the detected skin area.

According to the technology, even when unevenness occurs in an illuminance ratio, it is possible to detect a skin area with high accuracy.

Additional features and advantages are described herein, and will be apparent from the following Detailed Description and the figures.

### BRIEF DESCRIPTION OF THE FIGURES

FIG. 1 is a block diagram showing a configuration example of a detecting device to which the technology is applied;

FIG. 2 is a graph showing an example of a spectral reflection characteristic of a human skin;

FIG. 3 is a diagram showing an example when a skin area is detected without performing correction based on correction values;

FIG. 4 is a diagram illustrating unevenness in an illuminance ratio;

FIG. 5 is a diagram showing an example when a skin area is detected by correcting a reflectance difference detection signal;

FIG. 6 is a flowchart illustrating a skin detection process that the detecting device performs;

FIG. 7 is a diagram showing an example when a skin area is detected by correcting a threshold value; and

FIG. 8 is a block diagram showing a configuration example of a computer.

### DETAILED DESCRIPTION

Embodiments of the present application will be described below in detail with reference to the drawings.

1. Embodiment (Example when unevenness in an illuminance ratio is corrected by using a correction value according to a distance to a subject)

2. Modified Example

### 1. Embodiment

### Configuration Example of Detecting Device 1

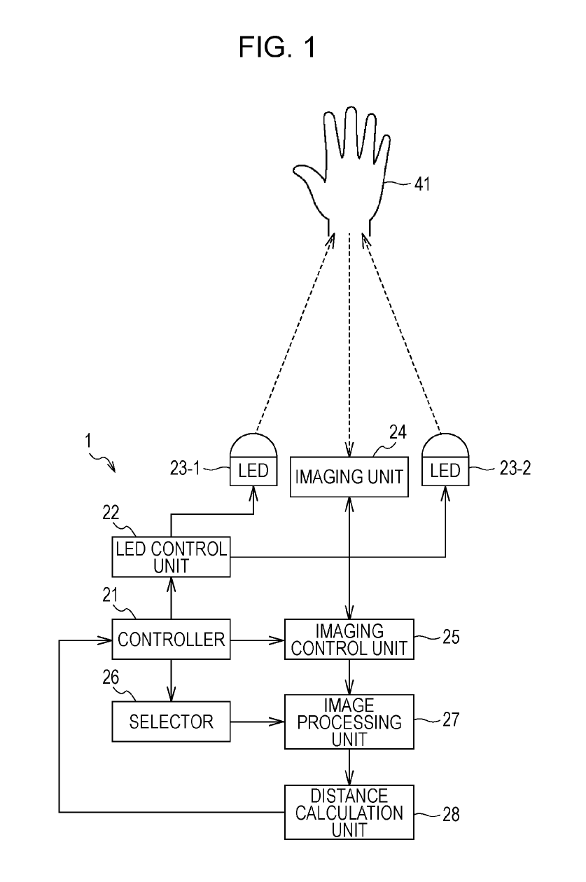

FIG. 1 shows a configuration example of a detecting device 1 according to an embodiment. The detecting device 1 is designed to detect a skin area (for example, of the face, a hand, or the like) of a person that is a detection target 41 from a captured image with high accuracy even when there is unevenness in an illuminance ratio of irradiating light from LEDs that are the irradiating light sources.

The detecting device 1 is composed of a controller 21, an LED control unit 22, LEDs 23-1 and 23-2, an imaging unit 24, an imaging control unit 25, a selector 26, an image processing unit 27, and a distance calculation unit 28.

The controller 21 collectively controls operations of each part in the detecting device 1. The LED control unit 22 controls the turn-on timing, turn-off timing, and light output levels of the LEDs 23-1 and 23-2 according to the control from the controller 21.

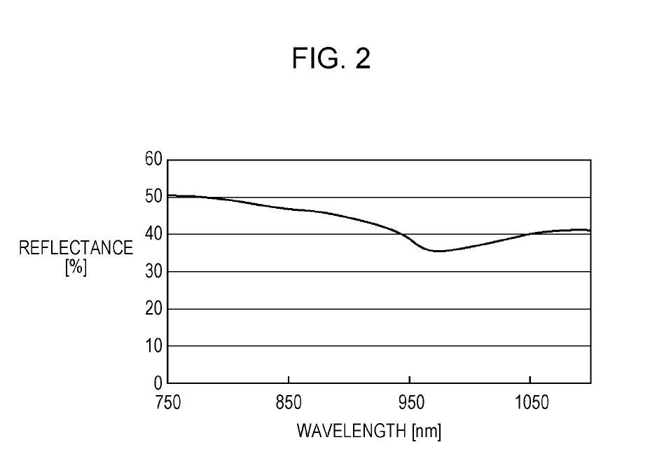

The LED 23-1 emits light of which the peak wavelength in the emission spectrum is λ1 (hereinafter, referred to as light with wavelength of λ1) according to the control from the LED control unit 22. The LED 23-2 emits light of which the peak wavelength in the emission spectrum is λ2 (hereinafter, referred to as light with wavelength of λ2) according to the control from the LED control unit 22. Furthermore, specific values of the wavelengths of λ1 and λ2 will be described later with reference to FIG. 2.

The imaging unit 24 includes a condenser lens, and imaging elements such as CCD, CMOS, or the like, and generates an image by sensing reflected light from a subject according to the control of the imaging control unit 25. An image generated when the LED 23-1 emits light is assumed to be a first image I1, and an image generated when the LED 23-2 emits light is assumed to be a second image I2. In addition, an image generated when neither of the LED 23-1 nor the LED 23-2 emits light is assumed to be a third image Ib.

In description provided below, a luminance value of a pixel present in a location (x,y) on the first image I1 is simply indicated by a luminance value I1(x,y) of the first image I1. Furthermore, in the luminance value I1(x,y), the location x represents the location of the first image I1 in the horizontal direction, and the location y represents the location of the first image I1 in the vertical direction.

To be more specific, in a case of a VGA (Video Graphics Array), for example, the first image I1(x,y) is composed of 640×480 pixels. In this case, in the luminance value I1(x,y), the location x of the first image I1 in the horizontal direction takes an integer from 1 to 640, and the location y of the first image I1 in the vertical direction takes an integer from 1 to 480.

Furthermore, in the description provided below, luminance values of the second image I2, the third image Ib, reflectance difference detection signals S and Sk to be described later, and a binarized skin image I3 are assumed to be indicated in the same manner.

In other words, in the following description, the luminance values of the second image I2, the third image Ib, the reflectance difference detection signal S, the reflectance difference detection signal Sk, and the binarized skin image I3 are indicated each simply by a luminance value I2(x,y) of the second image I2, the luminance value Ib(x,y) of the third image Ib, the luminance value S(x,y) of the reflectance difference detection signal S, the luminance value Sk(x,y) of the reflectance difference detection signal Sk, and the luminance value I3(x,y) of the binarized skin image I3.

The imaging control unit 25 controls the imaging timing of the imaging unit 24, gains in amplification of luminance values, or the like according to the control by the controller 21. In addition, the imaging control unit 25 outputs the first image I1, the second image I2, and the third image Ib generated by the imaging unit 24 to the image processing unit 27.

The selector 26 has an internal memory not shown in the drawing, and the memory stores a correction value K(x,y) for correcting unevenness in an illuminance ratio in advance according to the distance from the detecting device 1 to the detection target 41 (for example, a short distance, an intermediate distance, and a long distance). Furthermore, the correction value K(x,y) is obtained from experiments or the like performed in advance for storage.

The selector 26 selects and reads the correction value K(x,y) corresponding to the distance from the detecting device 1 to the detection target 41 among correction values K(x,y) of each distance stored in the internal memory according to the control of the controller 21, and supplies the data to the image processing unit 27. Furthermore, the correction value K(x,y) refers to a value for correcting, for example, the luminance value I2(x,y) of a pixel present in a location (x,y) on the second image I2.

The image processing unit 27 calculates, for example, the luminance value of the reflectance difference detection signal S, which is S (x,y)={I1(x,y)−K(x,y)×I2 (x,y)}/{I1(x,y)−Ib(x,y)}, based on the first image I1, the second image I2 and the third image Ib from the imaging control unit 25 and the correction value K(x,y) from the selector 26.

Then, the image processing unit 27 performs binarization for the reflectance difference detection signal S composed of a plurality of pixels each having luminance values S(x,y) obtained from the calculation, by comparing the reflectance difference detection signal S to a threshold value St used in binarization for detecting a skin area, and detects the skin area based on the binarized skin image I3 obtained from the result.

In addition, the image processing unit 27 supplies the binarized skin image 13 obtained by the binarization to the distance calculation unit 28.

The distance calculation unit 28 calculates a distance from the detecting device 1 to the detection target 41, for example, based on the size of the skin area on the binarized skin image I3 from the image processing unit 27 (for example, the size, width, or the like of the skin area), and supplies the data to the controller 21.

More specifically, for example, the distance calculation unit 28 retains a distance determination table in advance in which the size of the skin area is made to correspond to a distance, for each distance to the subject. Then, the distance calculation unit 28 reads a distance corresponding to the size of the skin area on the binarized skin image I3 supplied from the image processing unit 27 from the distance determination table retained in advance, and supplies the data to the controller 21.

Accordingly, the controller 21 controls the selector 26 based on the distance from the distance calculation unit 28, and selects the correction value K(x,y) corresponding to the distance from the detecting device 1 to the detection target 41.

Furthermore, the distance calculation unit 28 is designed to calculate a distance based on the size of the skin area on the binarized skin image I3 from the image processing unit 27 but may calculate a distance using any method if the distance calculation unit 28 can calculate the distance from the detecting device 1 to the detection target 41.

Specifically, for example, the distance calculation unit 28 may measure a distance using a laser range finder that measures a distance by radiating laser beams to the detection target 41, a stereo camera that measures a distance using two cameras provided with different parallaxes, or the like, instead of the binarized skin image I3 from the image processing unit 27.

Details of Image Processing Unit 27

Next, a process that the image processing unit 27 performs will be described with reference to FIGS. 2 to 5.

FIG. 2 shows a spectral reflection characteristic of human skin.

Furthermore, the spectral reflection characteristic has generality regardless of a difference in colors (difference in races), states (tanning or the like), or the like of human skin.

In FIG. 2, the horizontal axis represents the wavelengths of irradiation light irradiated on human skin, and the vertical axis represents reflectance of the irradiation light irradiated on the human skin.

This is unique in human skin, and in many cases, a change in the reflectance of portions other than human skin (for example, hair on the head, clothes, or the like) is minor at around 630 to 1100 [nm].

Furthermore, the combination of the wavelengths of λ1 and λ2 is a combination that has a relatively large difference in reflectance of human skin, and has a relatively small difference in reflectance of portions other than human skin.

Specifically, for example, in terms of the spectral reflection characteristic described above, the wavelength of λ1 is equal to or greater than 630 [nm] and equal to or less than 1000 [nm], and the wavelength of λ2 is equal to or greater than 900 [nm] and equal to or less than 1100 [nm] as the combination of the wavelengths of λ1 and λ2, and a combination of wavelengths in which the wavelength of λ1 is shorter than the wavelength of λ2 (the wavelength of λ1 <the wavelength of λ2) (more preferably, the wavelength of λ1+40 [nm]<the wavelength of λ2) is adopted.

The detecting device 1 detects the skin area in the first image I1 (or the second image I2) based on the difference in the reflectance. Therefore, it is necessary for the detecting device 1 to constantly maintain the illuminance ratio between the LED 23-1 and the LED 23-2 so that the difference between the luminance value I1(x,y) of the first image I1 and the luminance value I2(x,y) of the second image I2, which is {I1(x,y)−I2(x,y)}, corresponds to the difference in the reflectance.

In other words, ideally, it is necessary to constantly maintain the illuminance ratio so that the luminance value I1(x,y) of the first image I1 obtained when light with the wavelength of λ1 is radiated and the luminance value I2(x,y) of the second image I2 obtained when light with the wavelength of λ2 is radiated are the same as each other for an object having the same reflectance (for example, a mirror plane or the like) for the wavelengths of λ1 and λ2.

When the illuminance ratio is constant, the luminance value S of the reflectance difference detection signal S, which is S(x,y)={I1(x,y)−I2(x,y)}/{I1(x,y)−Ib(x,y)}, corresponds to the difference between the reflectance for light with the wavelength of λ1 and reflectance for light with the wavelength of λ2 for the detection target 41.

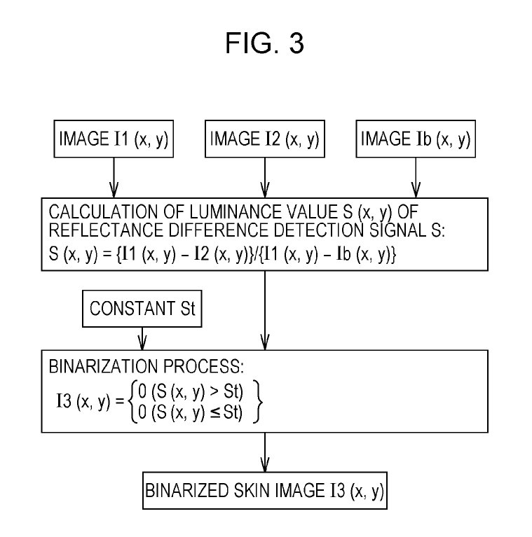

Therefore, as shown in FIG. 3, the detecting device 1 calculates the luminance value of the reflectance difference detection signal S, which is S(x,y)={I1(x,y)=I2(x,y)}/{I1(x,y)−Ib(x,y)}, based on the luminance value I1(x,y) of the first image I1, the luminance value I2(x,y) of the second image I2, and the luminance value Ib(x,y) of the third image Ib, and performs binarization with the threshold value St. To be more specific, the detecting device 1 performs binarization in which S(x,y) is converted to a luminance value of 0 when S(x,y)>St, and S(x,y) is converted to a luminance value of 1 when S(x,y)≦St.

Then, the detecting device 1 detects an area composed of pixels each having the luminance value of 0 as a skin area among the luminance values I3(x,y) of the binarized skin image I3 obtained by the binarization.

As such, when the illuminance ratio is constant, the skin area can be detected with high accuracy, in the manner as shown in FIG. 3.

However, since it is not possible to make the configuration and location of the LEDs 23-1 and 23-2 completely the same, it is not possible to maintain the illuminance ratio of light radiated from the separate LED 23-1 and LED 23-2 at a completely constant value.

Furthermore, according to experiments conducted by the inventor, when unevenness in the illuminance ratio falls within a predetermine range, it has been confirmed that a skin area can be detected with relatively high accuracy.

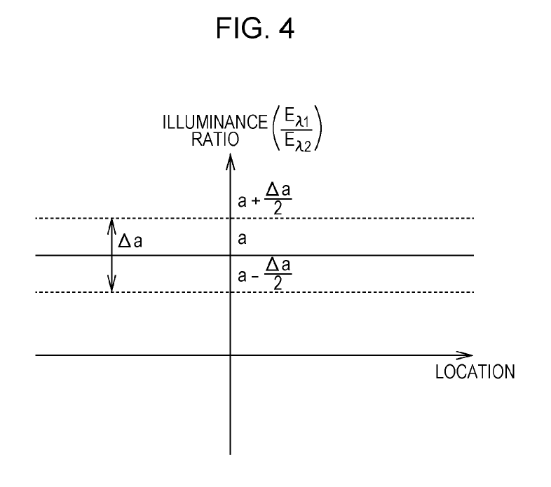

Next, FIG. 4 shows an example of unevenness in illuminance ratios.

In FIG. 4, the horizontal axis represents locations in the detection target 41 (for example, locations in the horizontal direction) to which light beams with the wavelengths of λ1 and λ2 are radiated. In addition, the vertical axis represents illuminance ratios (E_{λ1}/E_{λ2}) between the illuminance E_{λ1} (intensity of irradiated light) of light with the wavelength of λ1 irradiated at the location of the detection target 41 and the illuminance E_{λ2} of light with the wavelength of λ2 radiated at the location of the detection target 41.

As shown in FIG. 4, when an illuminance ratio (E_{λ1}/E_{λ2}) has a constant value of a, a skin area can be detected with high accuracy in the manner shown in FIG. 3.

However, if an illuminance ratio (E_{λ1}/E_{λ2}) does not have a constant value of a, the detection accuracy may decrease when a skin area is to be detected in the manner shown in FIG. 3. Particularly, for example, according to an empirical rule based on experience of the present inventor, when an illuminance ratio (E_{λ1}/E_{λ2}) does not fall within the range from a−Δa/2 to a+Δa/2, it is found that the detection accuracy drastically decreases. Furthermore, Δa indicates a value from 3[%] to 5[%] of a (a×3/100 to a×5/100).

Thus, in the embodiment, a skin area is made to be detected with high accuracy by using a correction value K(x,y) for correcting unevenness in illuminance ratios.

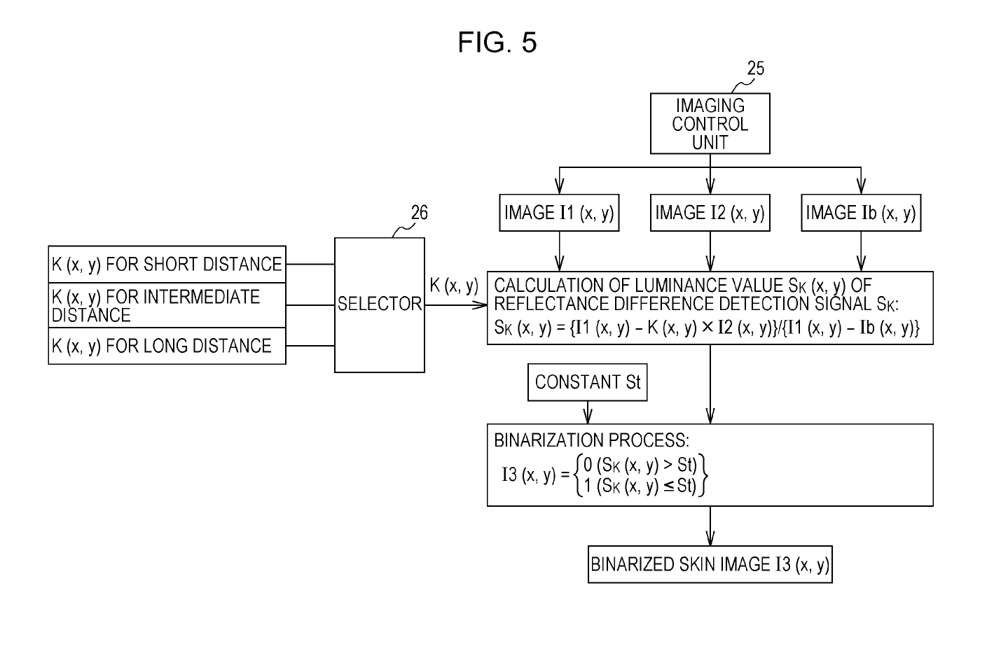

Next, FIG. 5 shows an example of a process performed by the image processing unit 27.

As shown in FIG. 5, the image processing unit 27 calculates the luminance value Sₖ(x,y) of the reflectance difference detection signal S, which is Sₖ(x,y)={I1(x,y)−K(x,y)×I2(x,y)}/{I1(x,y)−Ib(x,y)} of the reflectance difference detection signal Sₖ based on the luminance value I1(x,y) of the first image I1, the luminance value I2(x,y) of the second image I2, and the luminance value Ib(x,y) of the third image Ib from the imaging control unit 25, and the correction value K(x,y) from the selector 26.

Then, the image processing unit 27 performs binarization using the threshold value St for the reflectance difference detection signal S composed of a plurality of pixels each having a calculated luminance value Sₖ(x,y). In other words, for example, the image processing unit 27 performs binarization in which the luminance value Sₖ(x,y) of the reflectance difference detection signal Sₖ is converted to 0 when the value is greater than the threshold value St, and the value is converted to 1 when the value is equal to or smaller than the threshold value St.

Then, the image processing unit 27 detects an area composed of pixels each having the luminance value of 0 as a skin area, among the luminance values I3(x,y) of the binarized skin image I3 obtained by the binarization.

Furthermore, the correction value K(x,y) is set to such a value that the luminance value Sₖ(x,y) of the reflectance difference detection signal Sₖ is proportional to {(spectral reflectance of a subject for light with the wavelength of λ1)−(spectral reflectance of a subject for light with the wavelength of λ2)}.

Specifically, the correction value K(x,y) is obtained as shown below.

In other words, for example, the luminance value Sₖ(x,y) of the reflectance difference detection signal Sₖ having the correction value K(x,y) as a variable is calculated based on the first image I1, the second image I2, and the third image Ib obtained by imaging a subject having the same spectral reflectance of the wavelengths of λ1 and λ2 (for example, a mirror plane or the like).

Then, for example, the correction value K(x,y) can be obtained in advance by solving an equation Sₖ(x,y)=0 having the correction value K(x,y) as a variable for the correction value K(x,y), with regard to the calculated luminance value Sₖ(x,y) of the reflectance difference detection signal Sₖ.

Specifically, for example, the correction value K(x,y) satisfying the equation Sₖ(x,y)=0 is expressed by the following formula (1) or (2).

K(x,y)=I1(x,y)/I2(x,y) (1)

K(x,y)=(illuminance of light irradiated from the LED 23-1 at the location(x,y))/(illuminance of light irradiated from the LED 23-2 at the location(x,y)) (2)

Furthermore, the correction value K(x,y) is set to be obtained by solving the equation Sₖ(x,y)=0 for the correction value K(x,y) that is a variable, but the correction value K(x,y) may be obtained by solving Sₖ(x,y)St for the luminance value Sₖ(x,y) of the reflectance difference detection signal Sₖ obtained by imaging a subject (for example, other than the human skin) that has almost the same spectral reflectance of the wavelengths of λ1 and λ2, for the correction value K(x,y).

In addition to that, for example, the correction value K(x,y) can be obtained by solving Sₖ(x,y)>St for the luminance value Sₖ(x,y) of the reflectance difference detection signal Sₖ obtained by imaging a subject (for example, the human skin) that has different spectral reflectance of the wavelengths of λ1 and λ2, for the correction value K(x,y).

Incidentally, as described above, the correction value K(x,y) is set to be multiplied by the luminance value I2(x,y) of the second image I2, but it can be configured that the correction value K(x,y) is multiplied by the luminance value I1(x,y) of the first image I1 so that the correction value K(x,y) is used as a value for correcting the luminance value I1(x,y) of the first image I1. In this case, the luminance value Sₖ(x,y) of the reflectance difference detection signal Sₖ is {K(x,y)×I1(x,y)−I2(x,y)}/{K(x,y)×I1(x,y)−Ib(x,y)}.

Furthermore, the correction value K(x,y) is set to be multiplied by either the luminance value I1(x,y) of the first image I1 or the luminance value I2(x,y) of the second image I2, but may be subjected to division, instead of multiplication.

In addition, for example, in the luminance value Sₖ(x,y) of the reflectance difference detection signal Sₖ, the correction value K(x,y) may be subjected to addition or subtraction, not multiplication (or division) by the luminance value I1(x,y) of the first image I1 or the luminance value I2(x,y) of the second image I2.

In addition to that, for example, as the luminance value Sₖ(x,y) of the reflectance difference detection signal Sₖ, Sₖ(x,y)=S(x,y)+K(x,y), Sₖ(x,y)=S(x,y)−K(x,y), Sₖ(x,y)=S(x,y)×K(x,y), or Sₖ(x,y)=S(x,y)÷K(x,y) can be employed. The correction value K(x,y) is obtained even when any of the luminance values Sₖ(x,y) is employed in the same manner as described above.

Description of Operation of Detecting Device 1

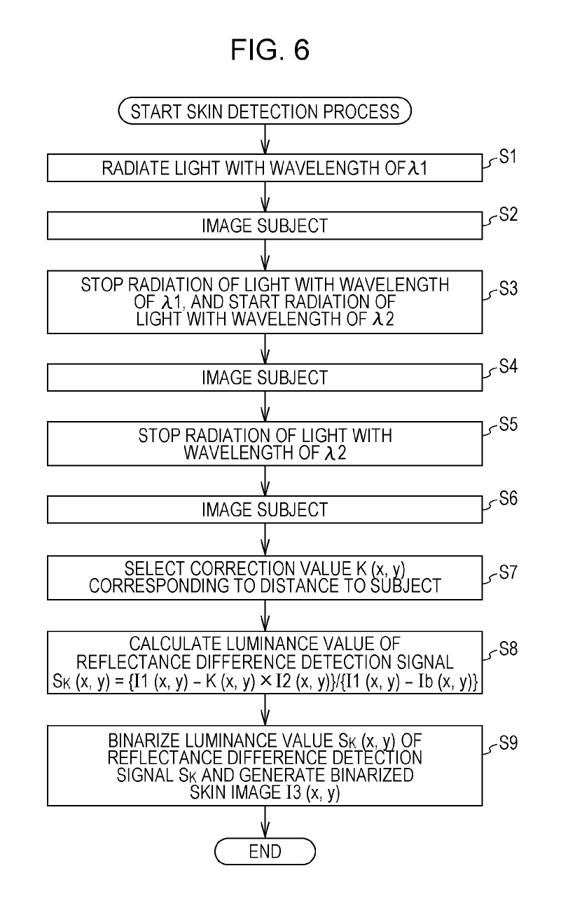

Next, a skin detection process performed by the detecting device 1 will be described with reference to the flowchart of FIG. 6.

In Step S1, the LED 23-1 irradiates a subject (for example, the detection target 41) with light with the wavelength of λ1 according to the control from the LED control unit 22. In Step S2, the imaging unit 24 generates the first image I1 by performing photoelectric conversion for the reflected light incident from the subject according to the control from the imaging control unit 25 and supplies the data to the imaging control unit 25.

In Step S3, the LED 23-1 turns the light off according to the control from the LED control unit 22. In addition, the LED 23-2 irradiates the subject with light with the wavelength of λ2 according to the control from the LED control unit 22. In Step S4, the imaging unit 24 generates the second image I2 by performing photoelectric conversion for the reflected light incident from the subject according to the control from the imaging control unit 25, and supplies the data to the imaging control unit 25.

In Step S5, the LED 23-2 turns the light off according to the control from the LED control unit 22. In Step S6, the imaging unit 24 generates the third image lb by performing photoelectric conversion for the reflected light incident from the subject according to the control from the imaging control unit 25, and supplies the data to the imaging control unit 25.

The imaging control unit 25 supplies the first image I1, the second image I2, and the third image Ib received from the imaging unit 24 to the image processing unit 27.

In Step S7, the distance calculation unit 28 calculates a distance from the detecting device 1 to the detection target 41, and supplies the result to the controller 21. The controller 21 controls the selector 26, for example, according to the distance supplied from the distance calculation unit 28. The selector 26 selects a correction value K(x,y) corresponding to the distance to the detection target 41 among a plurality of correction values K(x,y) (for example, the correction value K(x,y) for a short distance, the correction value K(x,y) for an intermediate distance, and the correction value K(x,y) for a long distance) stored in the internal memory according to the control from the controller 21. Then, the selector 26 reads the selected correction value K(x,y) from the internal memory, and supplies the value to the image processing unit 27.

In Step S8, the image processing unit 27 calculates, for example, a luminance value Sₖ(x,y) of the reflectance difference detection signal Sₖ, which is Sₖ(x,y)={I1(x,y)−K(x,y)×I2(x,y)}/{I1(x,y)−Ib(x,y)} based on the first image I1, the second image I2, and the third image Ib supplied from the imaging control unit 25 and the correction value K(x,y) supplied from the selector 26.

In Step S9, the image processing unit 27 performs binarization for the reflectance difference detection signal Sₖ composed of a plurality of pixels each having calculated luminance values Sₖ(x,y) by comparing the luminance value Sₖ(x,y) of the reflectance difference detection signal Sₖ to the threshold value St, and generates a binarized skin image I3 having the binarized value as a luminance value.

Then, the image processing unit 27 detects an area with the luminance value of 0 among the luminance values I3(x,y) of pixels composing the generated binarized skin image I3 as a skin area. Then, the skin detection process is ended.

According to the above-described skin detection process, since the reflectance difference detection signal S is set to be corrected to the reflectance difference detection signal Sₖ obtained when the illuminance ratio (E_{λ1}/E_{λ2}) is a constant value of a, using the correction value K(x,y) selected according to the distance from the detecting device 1 to the detection target 41, it is possible to detect a skin area with high accuracy, for example, even when the illuminance ratio (E_{λ1}/E_{λ2}) does not fall within the range from a−Δa/2 to a+Δa/2.

Therefore, for example, it is possible to detect a skin area with high accuracy in the detection target 41 in which a skin area is not able to be detected due to unevenness in the illuminance ratio (E_{λ1}/E_{λ2}), therefore it is possible to detect more skin areas in the detection target 41.

In addition, since the unevenness in the illuminance ratio (E_{λ1}/E_{λ2}) is suppressed, it is not necessary to provide a plurality of LEDs 23-1 and LEDs 23-2, or to provide a diffuser panel in front of the LEDs 23-1 and 23-2 for uniformly diffusing light, and therefore it is possible to simplify the configuration of the illumination system (the LEDs 23-1 and 23-2).

Furthermore, since the unevenness in the illuminance ratio (E_{λ1}/E_{λ2}) is suppressed, it is not necessary to sort out the illumination system based on optical characteristics of the LEDs 23-1 and 23-2, and therefore it is possible to suppress a cost rise resulting from selection of components to be used in the detecting device 1.

In addition, according to the skin detection process, since the luminance value S(x,y) of pixels composing the reflectance difference detection signal S is corrected by a unit of pixels to be the luminance value Sₖ(x,y) obtained when the illuminance ratio (E_{λ1}/E_{λ2}) is a constant value of a, it is possible to more accurately correct each luminance value S(x,y) affected by unevenness in the illuminance ratio (E_{λ1}/E_{λ2}) than when each luminance value S(x,y) of the reflectance difference detection signal S is corrected by one correction value.

### 2. Modified Example

In the above embodiment, the reflectance difference detection signal S is corrected to be the reflectance difference detection signal Sₖ using the correction value K(x,y), but it is possible to prevent erroneous detection of a skin area resulting from unevenness in the illuminance ratio (E_{λ1}/E_{λ2}) by correcting the threshold value St to be a threshold value St(x,y), instead of using the reflectance difference detection signal S.

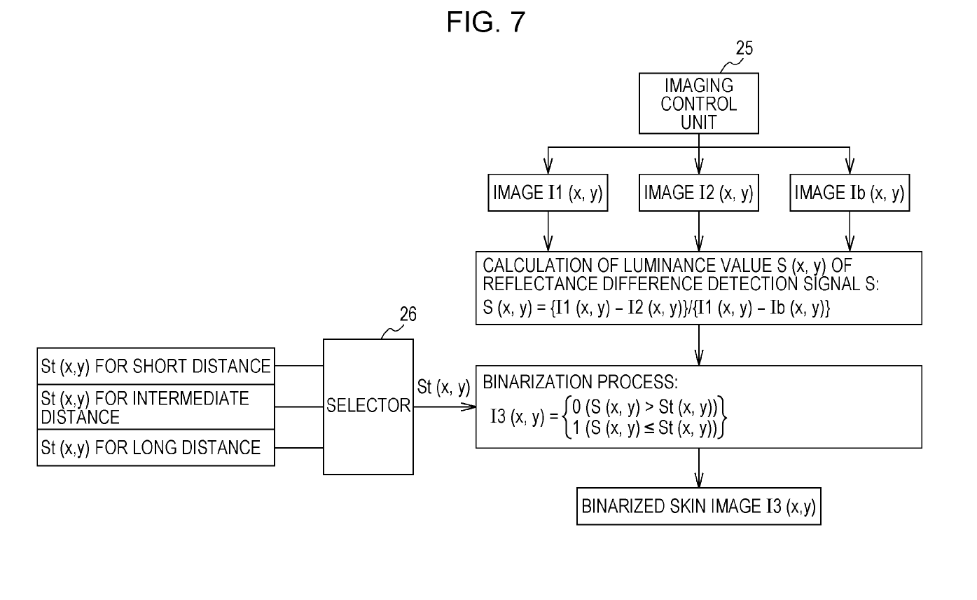

Next, FIG. 7 shows an example of a skin detection process performed such that the image processing unit 27 corrects the threshold value St using the correction value K(x,y) and uses a post-correction threshold value St(x,y)=StxK(x,y) obtained from the result.

The image processing unit 27 calculates the luminance value of the reflectance difference detection signal S, which is S(x,y)={I1(x,y)−I2(x,y)}/{I1(x,y)−I1)(x,y)} based on the first image I1, the second image I2, and the third image Ib from the imaging control unit 25 as shown in FIG. 7.

In addition, for example, the image processing unit 27 calculates a threshold value St(x,y)=St×K(x,y) based on the correction value K(x,y) from the selector 26.

Then, the image processing unit 27 detects a skin area by performing binarization for the calculated luminance value S(x,y) of the reflectance difference detection signal S using the calculated threshold value St(x,y).

The correction value K(x,y) of this case can be obtained in advance as described below.

In other words, for example, the correction value K(x,y) can be obtained by solving S(x,y)≦St(x,y)=St×K(x,y) of the luminance value S(x,y) of the reflectance difference detection signal S obtained by imaging a subject (for example, other than human skin) of which the spectral reflectance of the wavelength of λ1 and spectral reflectance of the wavelength of λ2 hardly change, for the correction value K(x,y).

In addition, for example, it is possible to obtain the correction value K(x,y) by solving S(x,y)=St(x,y)=St×K(x,y) for the luminance value S(x,y) of the reflectance difference detection signal S obtained by imaging a subject of which the spectral reflectance of the wavelength of λ1 and the spectral reflectance of the wavelength of λ2 are the same (for example, a mirror plane or the like), for the correction value K(x,y).

Furthermore, for example, it is possible to obtain the correction value K(x,y) by solving S(x,y)>St(x,y)=St×K(x,y) for the luminance value S(x,y) of the reflectance difference detection signal S obtained by imaging a subject of which the spectral reflectance of the wavelength of λ1 and the spectral reflectance of the wavelength of λ2 are different from each other (for example, human skin), for the correction value K(x,y).

Furthermore, the threshold value St(x,y) is set to be expressed by StxK(x,y) with a constant St and a variable K(x,y), but may be expressed by the threshold value St(x,y)=St÷K(x,y)=St×1/K(x,y). In addition to that, for example, the threshold value St(x,y)=St+K(x,y) or the threshold St(x,y)=St−K(x,y)=St+(−K(x,y)) may be possible. In those cases the correction value K(x,y) can be obtained in the same manner.

In addition, when the threshold value St(x,y) is used for the luminance value S(x,y) of the reflectance difference detection signal S, the first image I1 and the second image I2 are generated which are obtained by imaging a subject of which the spectral reflectance of the wavelength of λ1 and the spectral reflectance of the wavelength of λ2 are the same. Then, using the luminance value I1(x,y) of the generated first image I1 and the luminance value I2(x,y) of the generated second image I2, the correction value K(x,y)=(x,y)−I2(x,y) may be possible. In this case, the threshold value St(x,y)=K(x,y)+St=I1(x,y)−I2(x,y)+St.

In the description provided with reference to FIGS. 5 and 7, one correction value K(x,y) is adopted, but a plurality of correction values K(x,y) can be adopted.

Specifically, for example, by adopting two correction values K1(x,y) and K2(x,y), the luminance value Sₖ(x,y) of the reflectance difference detection signal Sₖ described with reference to FIG. 5 may be set to luminance value Sₖ(x,y)={K1(x,y)×I1(x,y)−K2(x,y)×I2(x,y)}/{K1(x,y)×I1(x,y)−Ib(x,y)}, thereby solving the correction values K1(x,y) and K2(x,y).

In addition, for example, by adopting three correction values K1(x,y), K2(x,y), and K3(x,y), it may be possible to set such that the luminance value Sₖ(x,y)={K1(x,y)×I1(x,y)−K2(x,y)×I2(x,y)}/{K1(x,y)×I1(x,y)−Ib(x,y)}, and the threshold value St(x,y)=St×K3(x,y), thereby solving the correction values K1(x,y), K2(x,y), and K3(x,y). In this case, the luminance value Sₖ(x,y) and the threshold value St(x,y) are compared to each other, thereby detecting a skin area.

In the embodiment, in any case shown in FIGS. 5 and 7, a correction value K(x,y) is made to be prepared in advance for three distance types which are a short distance, an intermediate distance, and a long distance, but in addition to that, for example, a correction value K(x,y) can be prepared in advance for one, two, or four or more distance types.

In addition, in the embodiment, it is set such that the luminance value S(x,y) of the reflectance difference detection signal S is {I1(x,y)−I2(x,y)}/{I1(x,y)−Ib(x,y)}, but in addition to that, for example, {I1(x,y)−I2(x,y)}, {I1(x,y)−I2(x,y)}/{0.5×I1(x,y)+0.5×I2(x,y)−Ib(x,y)}, {I1(x,y)−I2(x,y)}/I1(x,y), I1(x,y)−I2(x,y), or the like can be adopted as the luminance value S(x,y).

The above matter is equally applied to the luminance value Sₖ(x,y) of the reflectance difference detection signal Sₖ, and for example, {I1(x,y)−K(x,y)×I2(x,y)}, {I1(x,y)−K(x,y)×I2(x,y)}/{0.5×I1(x,y)+0.5×K((x,y)×I2(x,y)−Ib(x,y)}, {I1(x,y)−K(x,y)×I2(x,y)}/I1(x,y), I1(x,y)−K(x,y)×I2(x,y), or the like can be adopted as the luminance value Sₖ(x,y).

Furthermore, the correction value K(x,y) prepared in advance is made to be used in FIGS. 5 and 7, but the correction value K(x,y) may also be obtained by setting a distance to the detection target 41 to a variable for every time when the correction value K(x,y) is used and by using a function or the like that can calculate the correction value K(x,y) according to the distance. In this case, since it is not necessary to retain the correction value K(x,y) for every distance in the internal memory of the selector 26 in advance, the memory capacity can be reduced.

In addition, the detecting device 1 that is an embodiment can be built in an arbitrary electric apparatus, for example, a television receiver or the like. Such an electric apparatus can be made to execute a predetermined process according to movements in a detected skin area (for example, a hand of a subject or the like).

Next, a series of processes described above can be executed by dedicated software or by hardware. When the series of processes is executed by software, a program composing the software can be installed in a so-called built-in computer or a general-purpose personal computer, for example, that can perform various functions by various installed programs, from a recording medium.

### Configuration Example of Computer

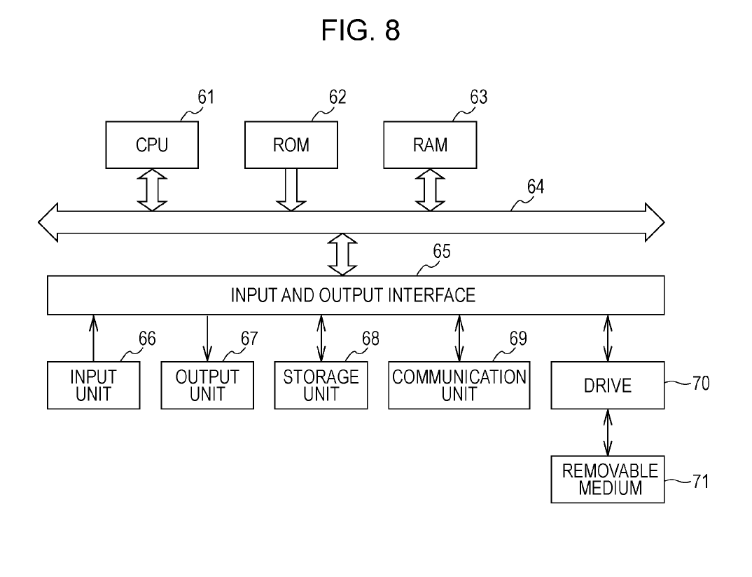

FIG. 8 shows a configuration example of a computer that executes a series of processes described above by a program.

A CPU (Central Processing Unit) 61 executes various processes with programs stored in a ROM (Read Only Memory) 62 or a storage unit 68. A RAM (Random Access Memory) 63 appropriately stores programs executed by the CPU 61, data, or the like. The CPU 61, the ROM 62, and the RAM 63 are connected to one another via a bus 64.

The CPU 61 is also connected to an input and output interface 65 via the bus 64. The input and output interface 65 is connected to an input unit 66 composed of a keyboard, a mouse, a microphone, and the like and an output unit 67 composed of a display, a speaker, and the like. The CPU 61 executes various processes according to instructions input from the input unit 66. Then, the CPU 61 outputs the process results to the output unit 67.

The storage unit 68 connected to the input and output interface 65 is composed of, for example, a hard disk, and stores programs executed by the CPU 61 and various data. A communication unit 69 communicates with external devices via a network such as the Internet, a local area network, or the like.

In addition, a program may be acquired via the communication unit 69 and stored in the storage unit 68.

A drive 70 connected to the input and output interface 65 drives magnetic disks, optical discs, magneto-optical discs, or a removable medium 71 such as a semiconductor memory when it is loaded thereon, and acquires programs, data, or the like recorded thereon. The acquired programs or data are transferred to the storage unit 68 according to necessity and stored.

A recording medium that records programs that are installed in a computer and in an executable state by the computer includes a magnetic disk (including a flexible disk), an optical disc (including a CD-ROM (compact disc-read only memory), and a DVD (digital versatile disc)), a magneto-optical disc (including an MD (mini-disc)), the removable medium 71 as a package medium composed of a semiconductor memory, or the like, or a hard disk that composes the ROM 62, or the storage unit 68 that temporarily or permanently records programs, or the like as shown in FIG. 8. Recording of programs on a recording medium is performed by using a wired or wireless communication medium such as a local area network, the Internet, or digital satellite broadcasting via the communication unit 69 that is an interface of a router, a modem, or the like according to necessity.

Furthermore, in the present specification, a step describing a program recorded on a recording medium includes not only a process performed in a time series manner according to the described order but also a process performed in a parallel or individual manner, not necessarily performed in a time series manner.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. An image processing apparatus which detects a skin area indicating human skin on an image, comprising:
a first irradiation unit which irradiates a subject with light with a first wavelength;
a second irradiation unit which irradiates the subject with light with a second wavelength that is a longer wavelength than the first wavelength;
a generation unit which generates a first image based on reflected light incident from the subject when the light with the first wavelength is radiated on the subject and generates a second image based on reflected light incident from the subject when the light with the second wavelength is radiated on the subject;
a correction unit which corrects at least one of a luminance value of the first image, a luminance value of the second image, and a threshold value to be compared to a difference between the luminance values of the first image and the second image using a correction value used in correction; and
a detection unit which detects the skin area based on the comparison result of the difference and the threshold value.

2. The image processing apparatus according to claim 1, wherein the correction unit corrects at least one of the corresponding luminance values or the threshold value for a coordinate of a pixel present on the first or the second image.

3. The image processing apparatus according to claim 1, further comprising:
a calculation unit which calculates a distance to the subject,
wherein the correction unit corrects at least one of the luminance value and the threshold value using a correction value corresponding to the distance to the subject among a plurality of correction values respectively corresponding to each different distance.

4. The image processing apparatus according to claim 1, wherein the correction unit corrects at least one of the luminance value and the threshold value by performing addition or subtraction of the correction value.

5. The image processing apparatus according to claim 1, wherein the correction unit corrects at least one of the luminance value and the threshold value by performing multiplication or division of the correction value.

6. The image processing apparatus according to claim 1, wherein the first wavelength of λ1 and the second wavelength of λ2 satisfy the relationship of the following formulae:
630[nm]≦1≦1000[nm]
900[nm]≦2≦1100[nm].

7. The image processing apparatus according to claim 1, wherein the first and second irradiation units radiate light in a state where the illuminance ratio of the illuminance of light with the first wavelength and illuminance of light with the second wavelength deviates from a predetermined value by 3% or more.

8. An image processing method of an image processing apparatus which detects a skin area indicating human skin on an image and includes a first irradiation unit, a second irradiation unit, a generation unit, a correction unit, and a detection unit, the method comprising:
irradiating a subject with light with a first wavelength by the first irradiation unit;
irradiating the subject with light with a second wavelength that has a longer wavelength than the first wavelength by the second irradiation unit;
generating a first image based on reflected light incident from the subject when light with the first wavelength is radiated on the subject and generating a second image based on reflected light incident from the subject when light with the second wavelength is radiated on the subject, by the generation unit;
correcting at least one of a luminance value of the first image, a luminance value of the second image, and a threshold value to be compared to the difference between the luminance value of the first image and the second image using a correction value used in correction by the correction unit; and
detecting the skin area by the detection unit based on the comparison result of the difference and the threshold value.

9. A program for causing a computer to function as:
a correction unit which corrects at least one of a luminance value of the first image, a luminance value of the second image, and a threshold value to be compared to the difference between the luminance values of the first image and the second image using a correction value used in correction; and
a detection unit which detects a skin area based on the comparison result of the difference and the threshold value,
the computer which controls an image processing apparatus for detecting a skin area indicating human skin on an image including a first irradiation unit which irradiates a subject with light with a first wavelength; a second irradiation unit which irradiates the subject with light with a second wavelength that is a longer wavelength than the first wavelength; and a generation unit which generates a first image based on reflected light incident from the subject when light with the first wavelength is radiated on the subject and generates a second image based on reflected light incident from the subject when light with the second wavelength is radiated on the subject.

10. An electronic apparatus which detects a skin area indicating human skin on an image, comprising:
a first irradiation unit which irradiates a subject with light with a first wavelength;
a second irradiation unit which irradiates the subject with light with a second wavelength having a longer wavelength than the first wavelength;
a generation unit which generates a first image based on reflected light incident from the subject when the light with the first wavelength is radiated on the subject and generates a second image based on reflected light incident from the subject when the light with the second wavelength is radiated on the subject;
a correction unit which corrects at least one of a luminance value of the first image, a luminance value of the second image, and a threshold value to be compared to a difference between the luminance values of the first image and the second image using a correction value used in correction;
a detection unit which detects the skin area based on the comparison result of the difference and the threshold value; and
an execution unit which executes a predetermined process based on the detected skin area.
